(19) United States
(12) Patent Application Publication
(10) Pub. No.: US 2007/0299687 A1
(43) Pub. Date: Dec. 27, 2007

(54) Inpatient system for patient-controlled delivery of oral transmucosal medications dosed as needed

(76) Inventors: Pamela Palmer, San Francisco, CA (US); Andrew I. Poutiatine, San Anselmo, CA (US); Thomas Schreck, Portola Valley, CA (US)

Correspondence Address: DLA Piper Rudnick Gray Cary LLP, Suite 800, 153 Townsend Street, San Francisco, CA, 94107-1957, US

(21) Appl. No.: 11/473,551

(22) Filed: Jun. 23, 2006

(51) Int. Cl. G06F 7/00

(52) U.S. Cl. 705/2; 700/213; 705/3

(57) ABSTRACT

A system is provided for controlled delivery of oral transmucosal medications as needed (PRN), which includes a drug delivery device having a detection mechanism for patient identification, safety features such as timed lock-out, the ability to be linked to an information network and one or more databases for storing prescription and patient usage information.

### FIELD OF THE INVENTION

The present invention relates to systems for administration and monitoring of oral transmucosal medications which are dosed “as needed” or PRN in an inpatient setting. The system includes a drug delivery device which requires RFID (radiofrequency identification) or other patient identification prior to drug administration. The drug delivery device has the ability to be linked to an information network, and one or more databases, such as a hospital database, which includes a variety of patient information. The system provides a number of mechanisms for monitoring the administration and use of PRN medications with the ability to adjust administration parameters based on input from hospital personnel.

### BACKGROUND OF THE TECHNOLOGY

Currently, patient-controlled delivery and tracking of the administration of oral transmucosal medications in the inpatient setting have clear limitations with regard to safety, ease of use and effective treatment with minimal side effects.

The high number of unnecessary medical emergencies and deaths in the hospital due to errors related to pharmaceutical administration of drugs such as opiates has been the focus of government studies and has received attention in the literature and press. (See, e.g., Dunn et al., Arch Dis Child. 2006 February;91(2):169-72). Such adverse events typically occur due to improper dosage of medications, the administration of a given drug to the wrong patient and the failure to monitor the physiological state of the patient before, during, and after the administration of such medications.

Controlled drug delivery technology represents an area of active research and controlled drug delivery systems offer numerous advantages as compared to conventional dosage forms, such as improved efficacy, reduced toxicity and improved patient compliance and convenience.

Conditions or objectives for the administration of PRN medications in the inpatient setting include the goal of rapidly producing the desired pharmacologic effect for purposes of analgesia, treatment of nausea, treatment of anxiety, treatment of insomnia, treatment of pruritis, treatment of preterm labor contractions, and treatment of migraines, while allowing the patient to have control over maintenance of the pharmacological effect such that the patient is comfortable and does not have to rely on assistance from hospital personnel. Further objectives for the administration of PRN medications in the inpatient setting include insurance that the medication be delivered in a safe manner, without over- or under-treating the patient.

Currently, the standard method for delivery of medications in the inpatient setting is by way of a PRN intravenous or oral dosage form which typically requires a nurse to administer the medication(s), or by way of a patient-controlled analgesia (PCA) machine which allows the patient to self-administer intravenous opioids. Oral medications suffer from delayed effectiveness, whereas the intravenous route suffers from often dangerously high peak plasma levels and an invasive route of delivery.

U.S. Patent Publication Nos. 20060100907, 20060089855 and 20050144043, describe a medication management system which includes a medication management unit associated with a medical device. The medication management unit downloads a medication order to the medical device after delivery data is validated and performs a number of other functions associated with validated drug delivery.

U.S. Patent Publication No. 20060089858 describes systems and methods for applying RFID (Radio Frequency Identification) technologies to medicine storage systems and use of an RFID reader to store information about medicine usage and transmit it to a central database.

U.S. Patent Publication No. 20060031099 discloses methods for the administration of pharmaceutical compositions using inkjet-based drug delivery devices and a healthcare system that provides for transfer of information from one or more healthcare nodes of the system to a “smart device”. The system enables real-time synchronization of data and records with the drug-delivery device and other healthcare nodes, such as medical professionals, computer systems, fluid reservoirs, or medical devices, such that computer systems within the healthcare system have up to date information for generating instructions for the administration of a drug, making decisions regarding the health of a patient, and creating a health history for the patient for later analysis.

U.S. Patent Publication No. 20060026035 discloses a computer aided interactive medical management information and control system and methods including one or more devices and a computing platform and associated software that assists a health care provider in performing treatment on a patient.

U.S. Patent Publication No. 20020087116 describes methods and apparatus for scheduling a patient for an appointment with a caregiver, for example, when an implantable device needs to be refilled for drug.

Although a number of references mention the concept of computer monitoring or control of drug delivery, the current invention provides a number of features associated with administration of oral transmucosal medications not taught or suggested by systems currently known in the art.

Current inpatient drug delivery systems suffer from adverse events due to improper dosing of medications, inadequate doses such that treatment is ineffective, administration of a given drug to the wrong patient and failure to adjust dosing parameters when the physiological state of the patient changes in the course of treatment.

There is a need for an inpatient drug delivery system that provides for improved safety and efficacy while eliminating or minimizing potential for error including for example: a security feature that prevents administration of the drug to an individual other than the patient for whom it was prescribed, a dose counting feature, a memory means for retaining information about drug delivery, and an interface for exchanging information with another device such as an information network.

There is therefore, substantial interest in the development of improved systems for drug delivery, in the inpatient/hospital setting.

### SUMMARY OF THE INVENTION

The invention provides systems and methods for delivery and monitoring of oral transmucosal delivery of a medication on an as needed (PRN) basis. The systems include a drug delivery device wherein information from the drug delivery device can be communicated via an information network to one or more databases. The drug delivery device may communicate bidirectionally with an information network by way of a docking station, wherein the docking station provides a connection to the information network, for example, a wireless computer network or hospital computer network.

The system may include a drug delivery device comprising a detection mechanism for patient identification, an information network comprising a computing platform and software comprising a search mechanism running on the computing platform, at least one information storage device connectable to the computing platform for storing the software, one or more databases for storing prescription and patient usage information, and a communication interface for establishing a bidirectional communication link within the system and to an external source.

In practicing the invention, the system is used for the treatment of a condition selected from the group consisting of pain, anxiety disorders and panic attacks, nausea, insomnia, symptoms of pre-term labor and migraine.

In one embodiment, the condition is pain and the drug is an opioid agonist.

In another embodiment, the condition is anxiety disorders or panic attacks and the drug is selected from the group consisting of XANAx™ (alprazolam) or 8-Chloro-1-methyl-6-phenyl-4H-s-triazolo [4,3-a][1,4]benzodiazepine; ATIVAN™ (lorazepam), or 7-chloro-5-(0-chlorophenyl)-1,3-dihydro-3-hydroxy-2H-1,4-benzo-diazepin-2-one; VALIUM™ (diazepam) or 7-chloro-1,3-dihydro-1-methyl-5-phenyl-2H-1,4-benzodiazepin-2-one; and oazepam (marketed under brand names Alepam®, Murelax®, Serax®, Serepax®, Seresta®) or -chloro-4-hydroxy-6-phenyl-2,5-diazabicyclo[5.4.0]undeca-5,8,10,12-tetraen-3-one.

In yet another embodiment, the condition is nausea and the drug is selected from the group consisting of serotonin3 (5-HT3) receptor antagonists, dopamine receptor antagonists and cannabinoid receptor agonists.

In a further embodiment, wherein the condition is insomnia and the drug is selected from the group consisting of benzodiazepine and non-benzodiazepine drugs, such as Ambien (zolpiderm), referred to as zolpiderm tartrate, in the imidazopyridine class; SONATA® (zaleplon) in the pyrazolopyrimidine class and LUNESTA (eszopiclone) the cyclopyrrolone class.

In yet a further embodiment, the condition is symptoms of pre-term labor and the drug is selected from the group consisting of beta-adrenergic receptor agonists, calcium channel blockers, and prostaglandin synthetase inhibitors.

In one more embodiment, the condition is migraine and the drug is selected from the ergot class and the triptan class of medications.

The prescription information includes information regarding the patient and may be stored in a hospital database.

The system provides for a search of one or more databases, such as a hospital database which have an index of patients, typically organized by medical record number and a software generated alert is initiated when a search indicates the possibility of a drug-drug interaction. The system provides a means for the alert to be transmitted to the prescribing physician and registered user who entered the information by way of an email, a text message, a page, a phone call or other communication.

The system includes a drug delivery device for administering one or more PRN medications to a patient. The drug delivery device may be connected to the information network by way of a docking station, using a connection selected from the group consisting of a computer (i.e., a USB port), a removable card (or other media), a phone line, or a wireless connection. When docking occurs, patient usage information may be transmitted to the information network, i.e. a hospital computer network, and stored in at least one database. The transmission is bidirectional and information may also be transmitted from the information network to the drug delivery device when it is docked.

The system further provides for collection of information on biological parameters of the patient using a docking station. The information on biological parameters of the patient may include, but is not limited to, pain score, anxiety score, insomnia score, uterine contraction count, temperature, pulse, blood pressure, respiratory rate, oxygen saturation, blood chemistry and bodily fluid chemistry information. Hospital personnel may assist the patient in collection of biological parameter information or the patient may conduct their own measurement(s), e.g., for pain score.

The device for administering a PRN medication typically includes a detection mechanism for patient identification such as an RFID tag, a password, a pass code, fingerprint information, optical information, voice recognition, facial recognition or the results from DNA analysis of a bodily fluid sample.

Verification of patient identification is required upon initial device activation and follow-up identification using an RFID tag or other means may be required prior to administration of each dose of medication, on a daily or other basis, in order for the device to remain activated. The frequency at which verification is required is determined and may be adjusted by the prescribing physician.

The system may further include at least one input device for manual entry of information into the system by a registered user by way of a microphone, a touch screen, a keyboard, or a graphical input device.

The system provides for manual entry of prescription information and changes in prescription information. Such manual entry may occur in response to an alert or for other reasons.

Information may be transmitted to, from and within the system by way of a telephone, an Internet connection, a WAN network connection, a LAN network connection, a wireless connection or a satellite connection.

In using the system, a medication is loaded into the delivery device using a cartridge or other means, and the device is docked to bidirectionally transmit information between the device and the system. If no alert is generated by the system, then the device is initially activated following verification of patient identity such that the medication can be dispensed to the patient.

The patient may self-administer the medication when the delivery device is in an activated state.

### DESCRIPTION OF THE DRAWINGS

FIG. 1 is a schematic depiction of the functional elements of the computer-assisted version of the PRN medication delivery and monitoring system of the invention, which includes a registered user and/or prescribing physician, also termed “qualified medical personnel” [1], who has received training in use of the system by the prescribing physician or trained hospital personnel; and who enters the prescription (Rx) information into an information network such that it is transmitted to a database, i.e. a hospital database [2]. The database is indexed by medical record number. When hospital personnel request that the prescription for a medication be filled by the pharmacy, the pharmacist [3] double checks the Rx information and patient information in the system. The system software checks for other prescriptions for the same patient and associated potential drug-drug interactions. If the prescription information is accurate and no drug-drug interaction detected, the medication delivery device [4] is filled with the prescribed medication, dispensed, then docked with a docking station [5], such that information can be bidirectionally transmitted between the information network and the device via the docking station. In most cases, then the patient identity is verified by an RFID tag or other means and the drug delivery device is unlocked (activated) [6] and ready for use. Alternatively, if a problem is detected with the prescription information or a drug-drug interaction is detected, an alert is initiated and sent via the information network to the prescribing physician and the registered user who input the prescription information prior to activating the device. The activated delivery device [6] is used to deliver medication to the patient [7] in a controlled manner. The one or more databases are part of an information network which can receive and send information to the drug delivery device by way of a docking station. In addition, information may be transmitted bidirectionally between the information network and the patient's chart [8]. A * indicates a step where an alert may be generated. Typically, the docking station is accessible by hospital personnel.

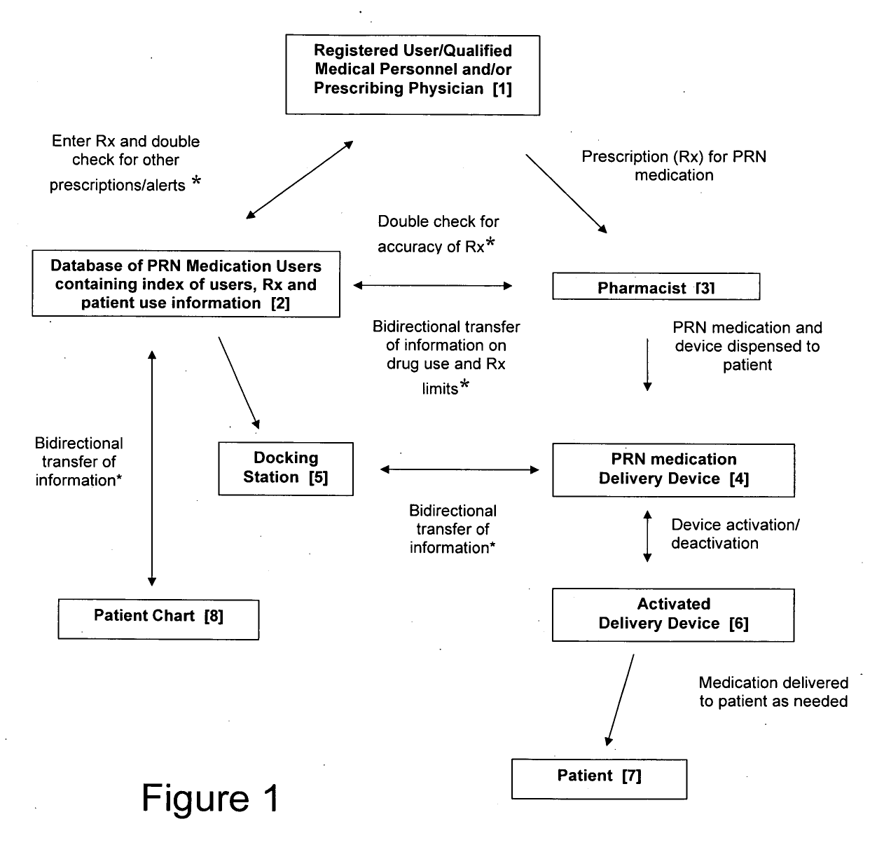

### DETAILED DESCRIPTION OF THE INVENTION

The following disclosure describes the systems and methods which constitute the invention. A detailed disclosure of the systems and methods of the invention for the delivery of PRN medications is provided herein.

The oral transmucosal PRN medication delivery and monitoring system of the invention is not limited to specific medications, formulations, dosages forms, delivery devices, or methods of use. As such, the systems and methodology for treatment of the medical condition of the patient described herein, may, of course, vary. It is also to be understood that the terminology used herein is for the purpose of describing particular embodiments only, and is not intended to limit the scope of the present invention.

It must be noted that as used herein and in the appended claims, the singular forms “a”, “and”, and “the” include plural references unless the context clearly dictates otherwise. Thus, for example, reference to “a drug formulation” includes a plurality of such formulations and reference to “a drug delivery device” includes systems comprising drug formulations and devices for containment, storage and delivery of such formulations.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the compositions and methodologies which are described in the publications which might be used in connection with the presently described invention. The publications discussed herein are provided solely for their disclosure prior to the filing date of the present application. Nothing herein is to be construed as an admission that the invention is not entitled to antedate such a disclosure by virtue of prior invention.

### Definitions

The term “PRN medication” as used herein is used with reference to drugs, the prescription and administration of which is “as needed”. As such, a “PRN medication” for treatment of pain, such as post-operative pain, nausea, anxiety, pruritis, symptoms of pre-term labor and the like is frequently administered at the request of the patient in the inpatient setting.

The term “formulation” or “drug formulation” or “dosage form” as used herein refers to a physical entity containing at least one therapeutic agent, meant for delivery to a subject. It may be in the form of a lozenge, pill, capsule, gel cap, membrane, strip, liquid, patch, film, gel, spray, gum, or other form.

The term “drug” as used herein is generally meant to refer to any substance that alters the physiology of an animal.

The term “drug” may be used interchangeably herein with the term “therapeutic agent” or “medication”. It will be understood that a “drug” formulation of the invention may include more than one therapeutic agent, wherein exemplary combinations of therapeutic agents include a combination of two or more compounds, wherein one or more of the combined compounds may be a controlled substance. The term “congener” as used herein refers to one of many variants or configurations of a common chemical structure.

The term “subject” is includes any subject, generally a mammal (e.g., human, canine, feline, equine, bovine, ungulate etc.), in which treatment for a disorder, such as management of pain or anxiety, is desired.

The term “transmucosal” delivery of a drug and the like is meant to encompass all forms of delivery across or through a mucous membrane. Examples of “transmucosal” delivery include, but are not limited to delivery via the oral, nasal, buccal, ocular, vaginal, and rectal mucosa. In particular, “oral transmucosal” delivery of a drug includes delivery across any tissue of the mouth, pharynx, larynx, trachea, upper respiratory tract or upper gastrointestinal tract, particularly including the sublingual, gingival and palatal mucosal tissues.

The term “therapeutically effective amount” means an amount of a therapeutic agent, or a rate of delivery of a therapeutic agent (e.g., amount over time), effective to facilitate a desired therapeutic effect, such as pain relief. The precise desired therapeutic effect (e.g., the degree of pain relief, and source of the pain relieved, etc.) will vary according to the condition to be treated, the tolerance of the subject, the drug and/or drug formulation to be administered, e.g., the potency of the therapeutic agent (drug), the concentration of drug in the formulation, and the like, and a variety of other factors that are appreciated by those of ordinary skill in the art. In one exemplary embodiment, the systems and methods of the invention find utility in the suppression or mitigation of pain in a subject suffering from pain that may be associated with any of a variety of identifiable or unidentifiable etiologies.

The term “treatment” or “management” of pain is used herein to generally describe regression, suppression, or mitigation of pain so as to make the subject more comfortable as determined by subjective criteria, objective criteria, or both.

The terms “qualified medical staff”, “qualified medical personnel” and “hospital personnel” may be used interchangeably herein and refer to one or more individuals who have access to the information network of the medication administration and monitoring system of the invention. Persons who are authorized to have access to the computer network are typically hospital staff who have been trained in use of the system and HIPPA compliance. System users may be given a user ID and become a “registered user” or “authorized user”. The user ID links the authorized person to the prescribing physician and is used to track all activities by the user relative to the medication administration and monitoring system of the invention. It will be understood that drugs are prescribed and the dose and frequency of administration is adjusted under supervision and/or authorization of a licensed physician. Such “qualified medical staff”, “qualified medical personnel” and “hospital personnel” may enter and retrieve information from the system under the supervision and/or authorization of the prescribing physician.

The terms “device for delivering a PRN medication” or “drug delivery device” and the like are used herein to refer to any device adapted for storage and/or delivery of a PRN medication delivered to the oral mucosa in any form such as a nanotab, pill, tablet, lozenge, gel, liquid, strip, film, spray, mist, gum, and the like.

“Operatively connected” as used herein means the components are provided in a device so as to function as intended to achieve an aim. For example, a memory device operatively connected to a CPU which is further operatively connected to a release mechanism or sensor may be meant to indicate that, upon actuation, the CPU communicates with the memory device to check the status or history of drug delivery, and then further communicates with the release mechanism (e.g., via a solenoid and a switch) to release and deliver a drug.

The term “network” as used herein typically refers to computer network that spans a large geographical area. Typically, a WAN consists of two or more local-area networks (LANs). Computers connected to a wide-area network are often connected through public networks, such as the telephone system. They can also be connected through leased lines or satellites. The largest WAN in existence today is the Internet. The term “wired network” as used herein refers to a network that relies on communication via a wired system or network such as the telephone or cable system. The term “network” as used herein may refer to a hospital network or computer system.

The term “wireless network” as used herein refers to communication via a system or network, without the need for a wired connection. A wireless network may consist of, but is not limited to, the following wireless technologies: wireless telephone, radio frequency, infra red, laser, optical light, or specific wireless communication protocols such as Bluetooth, 802.11, or any other wireless communication protocol.

“Radio Frequency Identification (RFID)” refers to an automatic identification method, which relies on storing and remotely retrieving data using devices called RFID tags or transponders. An RFID tag is a small object that can be attached to or incorporated into a product, animal, or person. RFID tags contain silicon chips and antennas to enable them to receive and respond to radio-frequency queries from an RFID transceiver.

“Sustained drug delivery” refers to release or administration of drug from a source (e.g., a drug formulation) over a protracted period of time, for example, over a period of a minute or more. Sustained drug delivery is in effect the opposite of bolus drug delivery.

The term “active agent” is used herein to refer to any therapeutically active agent.

The term “drug delivery device” means a device that delivers a PRN medication to the patient. The PRN medication delivery device is useful for controlled and safe self-administration of the drug via the oral transmucosal route.

The term “system that includes a PRN medication and delivery device” as used herein refers to a system for delivery of a PRN medication with ability to control and monitor efficacy, as well as maximum and minimum doses, such that the amount of medication delivered to the patient and the corresponding efficacy and safety are enhanced over currently available systems.

### General Features Of The Invention

The present invention encompasses systems and methods for the administration and monitoring of PRN medications which is effected and monitored using a drug delivery device. The system includes a means for the device to communicate with a computer network station or wireless communication protocol, e.g., by way of a docking station, a communication component for monitoring the physical state of the patient by measurement of one or more biological parameters, and transmitting drug delivery information and the biological parameter(s) of the patient to a network such that an alert is sent to qualified medical personnel if there is a problem (e.g., drug dosing outside of prescribed limits) and the drug dose is adjusted as needed. An “alert” may be manually generated or may be automatically generated by the software of the information network of the system of the invention. In either case, an alert causes an email, text message, page, phone call or other communication to be sent to the system user who entered the information into the database relative to the relevant prescription and to the prescribing physician.

The present invention is directed to a system for delivery and monitoring of the delivery of PRN medications, wherein the system may comprise an information network which includes a database of patients who have been prescribed a PRN medication, i.e., AcelRx™ device users. A delivery device, e.g., an AcelRx™ device is used to administer a PRN medication to the patient, as described for example in U.S. Application Ser. No. 60/756,937, expressly incorporated by reference herein in its entirety.

In using the system of the invention, the prescribing physician or a person authorized by the prescribing physician (referred to herein as an “authorized user” or “registered user”) will log into the information network and enter the prescription information into a database which has an index of patients receiving PRN medications. The prescription information is verified by the person dispensing the device loaded with the PRN medication prior to verifying the identity of the patient and giving the activated device to the patient. The prescription information includes background information on the patient such as the patient's medical record number. The name, dose and quantity of dosage units of the medication, and the name of the prescribing physician is also entered into the system. The information is collectively referred to herein as prescription information. When a pharmacist receives a prescription for a PRN medication for inpatient delivery using a drug delivery device such as an AcelRx™ delivery device, the pharmacy staff will verify that the drug being given to the patient matches the prescription information. A drug delivery device such as an AcelRx™ device is docked at the pharmacy in order to have the prescribing information downloaded into the device prior to delivery to the patient. In addition to the drug information listed above, lock-out times and docking times prescribed by the physician may also be downloaded into the device at the time it is dispensed.

Data may be entered into the information network using at least one input device, for example, a microphone, a touch screen, a keyboard, or a graphical input device.

The system of the present invention for delivery and monitoring of PRN medication(s), comprises software, i.e., AcelRx™ software which provides a number of features one of which is to generate an alert. One such feature is that addition of a patient name or other identifier, such as medical record number, to the database may trigger the software to automatically conduct a search to see if the drug dispensing information entered by the person dispensing the device matches the prescribing information. If the information does not match, an alert is issued. The system of the invention provides a mechanism to verify that that the correct patient is self administering the correct medication, with tracking of usage information as well as information on the biological condition of the patient such that hospital personnel and others such as the prescribing physician can have ready access to the information through an information network accessible throughout the hospital and via the Internet or other mobile device. This is not available using current systems.

The system does not require a paper prescription since the system software, i.e., AcelRx™ software, can provide a direct link between the prescribing physician and the dispensing of the medication by hospital personnel.

Personnel involved in prescribing or dispensing of delivery devices for administration of one or more PRN medications are generally hospital personnel who do not require specific training. Docking systems are used to download patient information/drug usage to and from the drug delivery device. This can be done in any location where there is a docking station, for example, in the patient's room, at a nurses' station, at a hospital pharmacy, etc. In some situations, the docking station is as simple as a data transmission port, i.e. a USB port. In other situations, the docking station is used to measure biological parameters of the patient.

In one embodiment, the PRN medication delivery and monitoring system of the invention also includes a database capable of data exchange via a docking system. The patient data in the database may include “prescription information” as well as “patient usage information”. Patient usage information may be downloaded/ transmitted from the drug delivery device into a database of the system of the invention. The information is typically transmitted from the device to the system by way of a docking station and the data transmission takes place by way of a bidirectional communication network which may be wireless or may include a direct wired or other connection. Such patient usage information includes but is not limited to, device information and drug usage information, such as the name of the drug in the device, dosage, total pill count used over various time frames, and lock-out time. Data on other medications the patient is taking concurrently with the PRN medication may be entered by the physician, pharmacy or hospital staff, processed by the system software, i.e., AcelRx™. An “alert” is generated by the system software if a possible drug-drug interaction is detected.

When the device used to deliver the PRN medication is docked, the system may also collect additional information that can be downloaded/transmitted to a database of the system of the invention.

Such additional information includes, but is not limited to, one or more biological or physiological parameters such as pain score or other information related to the medical condition of the patient (e.g. sleep score, anxiety score, mood score, uterine contraction score, etc) temperature, pulse, blood pressure, respiratory rate, oxygen saturation, blood chemistry and/or bodily fluid chemistry information.

The frequency with which the device is docked and information is transmitted to a database will vary and is controlled by the prescribing physician's or hospital personnel. For example, the device may be docked and information transmitted to the information network at any prescribed interval, e.g., one or more times per day. An alert will occur to both the patient, prescribing physician and/or local hospital personnel if the docking interval exceeds what was requested by the physician.

When the device is docked there is a bidirectional flow of information between the information network and the drug delivery device. Information that is transmitted from the drug delivery device to the computer network via a docking station includes, but is not limited to, information on use of the device such as number of dosage units delivered, time interval at which they were delivered, number of dosage units remaining in the device, and biometric, PIN or other security access information. The frequency at which the device must be docked is ordered by the physician and programmed into the system by the pharmacist or other hospital personnel. A dock may be designed to measure and transmit biomedical or physiological parameters (e.g. blood oxygen saturation and pulse) and symptom scoring (e.g. pain, anxiety) to the information network.

Information that is transmitted to the drug delivery device and patient dock from the computer network includes, information on allowable use of the device such as number of dosage units to be delivered, time interval at which they can be delivered (lock-out time), frequency of docking necessary, frequency of biometric or PIN ID entry by the patient, etc. Safe limits for the biological parameters that provide information on the physiological status of the patient can be transmitted to the device or changed as well. For example, if a patient is known to have a chronic respiratory condition and normally has oxygen saturations in the range of 91% then the lower limit of the alert range for oxygen saturation (usually 92-93%) may be programmed lower than 91% for this patient in the system by the physician.

When the patient leaves the inpatient setting and goes home, the patient may take the same or similar drug delivery device home with them and continue to self administer the same medication from home. Prior to the time when the patient leaves the hospital, the drug delivery device may be reprogrammed by hospital personnel as directed by the physician. After the patient leaves the hospital setting, the drug delivery device may be docked to upload drug usage information into the information network at a physician's office during a visit or remotely from the patient's home. Parameters that may be changed include, for example, the unit dose administration lock-out time, the frequency for biometric patient confirmation prior to delivering the medication, the frequency of docking that is required for the delivery device to continue to deliver the PRN medication, as well as other information such as battery life, etc. See for example, U.S. Ser. No. 11/429,904, expressly incorporated by reference herein.

Software associated with the information network of the system of the invention and accessible from any location with, access to the information network, e.g., via the Internet or cell phone technology, monitors incoming information downloaded/transmitted from the drug delivery device when it is docked. An “alert” is also generated by the system software if a scheduled docking is missed, dosing of the PRN medication is out of the prescribed range, there is evidence that the device has been tampered with or if the device has an empty cartridge, i.e. contains no medication.

Once qualified medical personnel, e.g., from the prescribing physician's office, or hospital staff for inpatients, become aware of the “alert”, staff will contact the patient to determine the problem. It follows that the PRN medication administration and monitoring system of the present invention is a closed-loop system.

In one exemplary aspect, the PRN medication delivery system of the invention provides for oral transmucosal delivery of a controlled substance such as an opioid agonist for the treatment of acute or break-through pain.

The drug delivery device has a number of features that provide for improved safety and ease of use over currently available systems including a security feature that requires patient identification prior to gaining access to the stored drug, a lock-out feature, a dose counting feature, a memory means for retaining information about dose delivery, and an interface for bidirectional exchange of information with another device such as a computer.

A given patient may be taking more than one PRN medication. In one aspect of the invention, such a patient may use two or more drug delivery devices, each of which can be docked in a docking station in order to down load drug dispensing information for each drug into the information network such that the information is stored in a database. Alternatively, a single drug delivery device may be used to deliver more than one medication.

A drug delivery device for use in conjunction with the system of the invention may be used multiple times or be disposable such that it is discarded when all of the medication initially loaded into the device has been delivered.

A drug delivery device of the system of the invention has the capacity to store historical device use/drug delivery information and communicate such information with another device or computer such that the data is stored in one or more databases. For example, such information may be communicated by downloading stored information to an information network using a physically wired interface, such as a USB or any other communication connection. Alternatively, information may be communicated via a wireless system. Such information may include historical use information, for example the number of dosages stored and delivered, and the times of delivery.

The device comprises a means to confirm that the individual attempting to dispense the drug is the patient for which the drug was prescribed, i.e., by way of a detection mechanism for patient identification such as an RFID tag, password, pass code, or biometric identifier, e.g., such as fingerprint information, optical iris information (i.e. a retinal scan), voice recognition, facial recognition (i.e. visual scan image recognition of facial features), or gene or DNA characteristics obtained from a bodily fluid sample. This serves to confirm that the correct patient is receiving the drug and minimizes the possibility for error or inappropriate use of the drug. The prescribing physician will determine the initial frequency of patient identification required for use of the device. This information may be adjusted at any time by a registered user of the PRN medication administration system of the invention.

The device may have colored or other visual, audible, or tactile identifiers to communicate the dosage contained therein.

The drug delivery device may include a microprocessor (CPU) in communication with a memory means and a display means that enables the device to monitor and control dosing, dose frequency, communication, synchronization, user identification, and schedule, and access to the doses and to store programmed and historical information.

In another aspect, the device is designed to track and communicate the total number of doses remaining in the device to allow anticipation and scheduling of refilling. The device also may record and track drug usage and communicate this, via a wireless network, electronic docking or other means, such that the information is transmitted and stored in the information network and accessible by qualified medical personnel, who can monitor the patient's drug use and adjust the dose as needed.

In some embodiments, the device may be remotely programmed to allow oversight by qualified medical personnel and therefore provides a means for management and optimization of the administration of PRN medications, one or more of which may be a controlled substance. The delivery device may include a radio frequency identification (RFID) system or other remote operation system that provides a unique key for each device that must be proximal to the device for operation, so as to prevent accidental or intentional tampering, abuse, or access to the drug by an unauthorized individual.

The system may be used in such a way as to provide for delivery of a combination of medications, one example of which is an opioid antagonist in conjunction with an opioid and/or an addiction control substance such as buprenorphine, in a configuration that prevents intentional diversion or tampering.

In many cases, the docking station is at a nursing station in a hospital, a hospital pharmacy or other location in the inpatient setting. The docking station provides a means for downloading drug delivery information from the drug delivery device, which allows for real-time reprogramming of the device parameters by the physician. For example, if the physician prescribes a different medication, a different strength of the same medication or changes the “lock-out” time limiting the number of doses the patient can self administer, then the physician enters the new information into the information network, and the device is docked to update the revised prescription information.

The docking station may include a power supply and provides a means for transmission of drug delivery information from a drug delivery device through the network such that it is recorded in a database accessible by system users. The information may be transmitted through a wireless, local area network (LAN) or wide area network (WAN) to the Internet via the docking station. The docking system can link into an information network by way of a computer, removable card (or other media), phone line, wireless or other connection.

In this way the PRN medication delivery and monitoring systems of the invention enable greater oversight and care management by medical personnel.

### Current Systems for Administration of PRN Medications

PRN medications are currently administered in the inpatient setting for a variety of disorders, including pain management, treatment of anxiety or insomnia, treatment of nausea and treatment of pruritis. Other conditions require PRN use of medications in the hospital, for example treatment of preterm labor contractions or treatment of migraine. Examples of medications that are not dosed on a PRN or “as needed” basis are chemotherapeutic agents, antibiotics, anti-coagulants, etc. These medications are not given based on the patient's symptoms, but rather on a fixed dose schedule.

The methods and systems of the current invention are applicable to any situation where the patient may self-administer a medication on a PRN or “as needed” basis, in an inpatient setting, i.e. hospital setting, based on their symptoms (e.g. level of pain, number of uterine contractions, etc.)

PRN medications may be administered by any of a number of routes including oral, transmucosal (i.e. sublingual, intranasal, buccal), subcutaneous injection, intramuscular injection, transdermal, and intravenous. Therefore the drug delivery device may be constructed in any of a variety of ways that enable delivery of the various forms in which the PRN medication is administered. For example, the drug delivery device will vary such that it is able to deliver any of a number of dosage forms, including, but not limited to: pills, sublingual lozenges, patches, suppositories, injectable syringes, sprays, gels, liquids, gum, etc. It will be understood that the delivery route and configuration of the drug delivery device will not affect the bidirectional communication, monitoring and control aspects of the system of the invention. The present invention relies on drug delivery by the oral transmucosal route.

Although the oral gastrointestinal route of administration is a widely used route of administration, it suffers from disadvantages in that absorption of drugs may be reduced by the delay in gastric uptake, first-pass metabolism of the drug may dramatically reduce the bioavailability and furthermore, and nausea and vomiting may limit the usefulness of this route of administration. Thus the oral gastrointestinal route is unsuitable in many instances.

The sublingual route offers many theoretical advantages for drug administration. Absorption occurs directly into the systemic circulation thereby avoiding first-pass metabolism. This is also true for the intranasal and buccal routes. Another advantage of the sublingual route over the oral gastrointestinal route is that many hospitalized patients are “NPO” (restricted from oral input (food, liquids or medications)) or have severe nausea and therefore can not ingest an oral medication. The sublingual route can be used in patients who are NPO and it lacks the invasive administration of the intravenous route The oral transmucosal route also is advantageous since a transition from inpatient to outpatient use of the medication can occur with no change in the route of administration. This is not true for intravenous administration.

Subcutaneous injection and intramuscular injection represent another technique for delivery of drugs, however this requires invasive access and produces discomfort for the patient and therefore is not highly desirable.

Intravenous administration has been routinely used in the inpatient setting, but is rarely used as a transition to the outpatient setting due to difficulty in obtaining intravenous access as an outpatient and also because intravenous opioids, for example, are inherently dangerous if the patient is left unsupervised for even a short period.

### Examples of Use of PRN Medications

### Use Of Opioids

Opioids are powerful analgesics and are utilized to treat both acute and chronic pain of moderate to severe intensity throughout the world. However, they can also have severe respiratory depressive effects if not used appropriately and suffer from a high abuse potential. In 1998, a total of 36,848 opiate exposures (pure and mixed preparations) were reported to US poison control centers, of which 1227 (3.3%) resulted in major toxicity and 161 (0.4%) resulted in death. The predominant cause of morbidity and mortality from pure opioid overdoses is via respiratory complications.

Opioids are still widely used for the treatment of pain, and are generally delivered via numerous routes of administration, including but not limited to intravenously, orally, transmucosally, epidurally, intrathecally, transdermally, subcutaneously and intramuscularly. Opioids exert their actions via the mu opioid receptor, which is located on peripheral nerve terminals, both pre- and post-synaptically in the spinal cord, brainstem, mid-brain and cortical regions associated with sensory and pain processing.

Opioids are known to produce physical dependence, possible addictive behaviors and tolerance with long-term use. In one aspect of the invention, the administration of a PRN medication is effected and monitored using the drug delivery system of the invention wherein the PRN medication includes an opioid agonist. There are many types of opioids, including mu-opioid receptor agonists such as endogenous agonists, e.g. beta-endorphin; endomorphins; small peptide agonists, e.g. DAMGO (D-Ala, N-Me-Phe, Gly-ol)-enkephalin or DALDA (H-Dmt-D-Arg-Phe-Lys-NH2); non-peptide agonists, such as morphine, hydromorphone, fentanyl and fentanyl analogues, such as sufentanil, alfentanil, remifentanil, buprenorphine, oxycodone, tramadol, etorphine, levorphanol, etonitazene and analogues, tilidine and analogues, e.g. the active metabolite nortilidine, loperamide and piritramide; delta-opioid receptor agonists, such as: endogenous agonists, e.g. met-enkephalin (Tyr-Gly-Gly-Phe-Met) and leu-enkephalin (Tyr-Gly-Gly-Phe-Leu); small peptides, e.g. DADLE (D-Ala 2, D-Leu 5) enkephalin or DPDPE (tyrosyl-2,6-3H(N)-(2-D-penicillamine-5-D-penicillamine)-enkephalin); non-peptide agonists, such as BW373U86 (±)-4-(a-R)-a(2S,5R)-4-allyl-2,5-dimethyl-1-piperazinyl)-3-hydroxybenzyl)- N,N-diethylbenzamide or SNC80 (±)-4-(a-R)-a(2S,5R)-4-allyl-2,5-dimethyl-1-piperazinyl)-3-methoxybenzyl)-N,N-diethylbenzamide; kappa-opioid receptor agonists, such as: endogenous agonists, e.g. dynorphin A arylacetamides, e.g. spiradoline (U62, 066), U69,593 ([5alpha,7alpha,8beta]-N-methyl-N-[7-[1-pyrrolidinyl]-1-oxaspiro[4.5]dec8-yl]-benzenacetamide), U50,488, benzomorphans, e.g. cyclazocine, bremazocine, pentazocine, Nalfurafine, salvinorin A; and ORL-1 receptor agonists, such as: endogenous agonists, e.g. nociceptin; small peptides, e.g. Ro 64-6198 ((1S,3aS)-8-(2,3,3a,4,5,6-hexahydro-1H-phenalen-1-yl)-1-phenyl-1,3,8-triaza-spiro[4.5]decan-4-one).

In one aspect of the invention, the administration of a PRN medication is effected and monitored using a drug delivery system of the invention wherein the PRN medication includes one or more opioid analogues, e.g., sufentanil plus an opioid such as fentanyl, alfentanil, or remifentanil, or opium alkaloids such as morphine and codeine; semi-synthetic opioids such as heroin and oxycodone; and fully synthetic opioids such as pethidine and methadone, that have structures unrelated to the opium alkaloids.

In alternative embodiments, the drug delivery system of the invention is used to deliver at least one non-opioid drug or a combination of at least one opioid drug or non-opioid drug and one or more other drugs.

Examples of the classes of drugs that are administered for analgesic efficacy include but are not limited to: anti-inflammatory drugs, such as non-steroidal anti-inflammatory drugs (including cyclooxygenase inhibitors and lipoxygenase inhibitors), steroid anti-inflammatory drugs, acetaminophen, cytokine antagonists, tumor necrosis factor antagonists, prostaglandin receptor antagonists. Also included are drugs that are analgesic via non-anti-inflammatory mechanisms, such as sodium channel blockers, N-type calcium channel blockers, monoamine uptake inhibitors, n-methyl-d-aspartate receptor antagonists, gamma aminobutyric acid (GABA)-A or GABA-B receptor agonists, or other receptor agonists or antagonists or enzyme inhibitors known by one skilled in the art to be of analgesic benefit.

Examples of drugs administered to avoid abuse may include but are not limited to naloxone and naltrexone or other opioid receptor antagonists. Examples of drugs added to reduce opioid-induced side effects may include but are not limited to: anti-pruretic drugs, such as anti-histamines, anti-constipation drugs or gut stimulants, such as metoclopramide, anti-sedation drugs, such as stimulants, (e.g. modafinil) and anti-emetic drugs, such as meclizine or dimenhydrinate.

Opioid antagonists include mu-opioid receptor antagonists such as naltrexone; naloxone; peptide antagonists, e.g. D-Phe-Cys-Tyr-D-Trp-Orn-Thr-Pen-Thr amide beta-funaltrexamine; delta-opioid receptor antagonist such as naltriben and naltrindol; kappa-opioid receptor antagonists such as nor-binaltorphimine and 5′-acetamidinoethylnaltrindoloe; and ORL-1 receptor antagonists such as Phe1 {Psi} (CH2-NH) Gly2]nociceptin (1-13) NH2 and SB-612111 ((−)-cis-1-Methyl-7-[[4-(2,6-dichlorophenyl)piperidin-1-yl]methyl]-6,7,8,9-tetrahydro-5H-benzocyclohepten-5-ol).

PRN medications may be given to women who are having preterm labor. These drugs are administered to help slow or stop labor contractions. Examples of drugs administered to as a preterm labor drug, include but are not limited to beta-adrenergic receptor agonists such as terbutaline, ritodrine, calcium channel blockers (e.g., nifedipine), prostaglandin synthetase inhibitors (e.g., indomethacin, ketorolac, sulindac) and magnesium sulfate.

PRN medications may be given to patents to treat anxiety disorders and panic attacks. Examples of drugs administered to treat anxiety disorders and panic attacks, include but are not limited to drugs of the benzodiazepine class, such as alprazolam, lorazepam, diazepam and oxazepam.

PRN medications used to treat nausea include, but are not limited to, the serotonin3 (5-HT3) receptor antagonists, such as ondansetron, dolasetron and granisetron, the dopamine receptor antagonists, such as droperidol, prochlorperazine and metaclopramide and cannabinoid receptor agonists.

PRN medications used to treat insomnia include, but are not limited to, drugs of the benzodiazepine class, such as triazolam, temazepam, estazolam, and the non-benzodiazepine drugs, such as Ambien (zolpiderm), referred to as zolpiderm tartrate, in the imidazopyridine class;.SONATA® (zaleplon) in the pyrazolopyrimidine class and LUNESTA (eszopiclone) the cyclopyrrolone class.

PRN medications may be given to patients to treat migraine attacks. Examples of drugs administered to treat migraine include, but are not limited to, the ergot class of medications, such as ergotamine and dihydroergotamine, and the triptan class of medications, such as sumatriptan, frovatriptan and rizatriptan.

Those of skill in the art will appreciate that the drug delivery systems of the current invention provide advantages over current methods by controlling the administration of PRN medications and monitoring the delivery process such verification of patient identity prior to administration can be required and the dose can be optimized for efficacy while reducing side effects.

The present invention provides a mean for insuring that the correct patient receives the medication, that potential drug-drug interactions are detected, that the prescribed dose is adjusted as needed, and that the delivery process is monitored in a manner effective to maximize efficacy while reducing side effects and minimizing the potential for abuse.

There is a continuing, unfilled need for a system for administration of PRN medications that includes a drug delivery device that can accurately deliver a given medication to the correct patient in a manner that is cost-effective, minimizes the risk of error, is resistant to pilferage, is not labor-intensive and minimizes the possibility for abuse. The drug delivery device of the system of the present invention is easily handled, portable, relatively inexpensive, is child-proof and has theft-proof safety features and allows for patient identification prior to use as well as providing a lock-out feature. In addition, the system provides for multi-unit dosing, such that many doses of a given medication can be housed in a single device.

### Exemplary Uses of the PRN Medication Administration and Monitoring System of the Invention Include the Following:

Inpatient treatment and monitoring of a post-operative patient after surgery to treat acute pain (e.g. opioids).

Inpatient treatment and monitoring of a patient suffering from recurring nausea.

Inpatient treatment and monitoring of a patient suffering from periodic anxiety attacks (e.g., with benzodiazepines).

Inpatient treatment and monitoring of a patient suffering from preterm labor

Inpatient treatment and monitoring of a patient to treat migraine headaches.

Inpatient treatment and monitoring of a patient to treat insomnia.

The ability to insure that the correct drug is administered to the correct patient based on RFID, biometric or another patient identification system prior to drug administration

The ability to deter attempts by persons other than the patient to self-administer medication through the use of RFID, biometric or another patient identification system.

The ability to avoid accidental misuse of a controlled medication due to unclear instructions or patient forgetfulness by providing a drug delivery device with an electronic lock-out timer and a patient reminder alert.

The ability to regulate dosing frequency remotely based on a patient's parameters', such as pain score, by reprogramming the device as instructed by the hospital staff/physician.

The ability to generate electronic and printable information relative to drug dosing over any given time frame to transit the information electronically to a patient chart which is then accessible via an information network.

The ability for a patient to begin self-administering a PRN medication with a drug delivery device, i.e. an AcelRx device while in the hospital or clinic, then go home and use the same device to administer the same medication. This is possible when routes other than intravenous are used to deliver the medications, such as oral transmucosal.

The present invention is described by reference to the following examples, which are offered by way of illustration and are not intended to limit the invention in any manner. Standard techniques well known in the art or the techniques specifically described below are utilized. Therefore, the description and examples should not be construed as limiting the scope of the invention, which is delineated by the appended description of exemplary embodiments.

### EXAMPLES

For purposes of illustration a few exemplary systems and scenarios for their use are provided below:

### Example 1

### Exemplary Inpatient System For Delivery And Monitoring Of Administration Of Sufentanil

A 56 year-old gentleman is taken to the recovery room after having a partial colectomy. He receives intravenous (IV) fentanyl from the nurse in the recovery room until he is comfortable and then he is transferred to his post-surgical hospital room. He is then given a hand-held device by his nurse, which is RFID tagged to the patient and dispenses, when placed under the tongue, a very small sublingual tablet containing 5 microgram dose of sufentanil in a controlled manner, including a 10 minute lock-out time. This device has been ordered by the surgeon for his post-operative pain control. The device is in electronic communication with the electronic nursing chart for this patient. As the patient dispenses the tablets sublingually on an “as-needed” basis for pain control, total amount dispensed every shift is automatically recorded in his chart. The dispenser also contains a mechanism for the patient to record his pain score, which will be electronically transmitted to the chart as well. The patient loves the device since it weighs less than a pound and he can wear it around his neck when he goes for a walk around the hospital floor instead of pushing a 15 pound IV patient-controlled analgesia (IV PCA) machine around on an IV pole. He also likes that fact that the dosing can be repeated every 10 minutes and doesn't require a functional IV since he has had his IV infiltrate and it took the nurse 45 minutes to replace it. Furthermore, his physician has ordered a similar device for the patient to use at home after he is discharged from the hospital so there will be no risk of transition errors in his analgesic regimen.

### Example 2

### Exemplary Inpatient System For Delivery And Monitoring Of Administration Of Terbutaline

A 36 year-old pregnant woman is admitted to the obstetrical floor in a hospital for pre-term labor. She is having contractions 10 times per hour. She is placed on bed-rest and given a hand-held device which dispenses very small sublingual tablets containing 500 microgram doses of terbutaline in a controlled manner, including a 30 minute lock-out time. The device has been ordered by her obstetrician to treat her pre-term labor and it is RFID tagged to the patient. The device has a pulse rate detection unit, which will not allow a tablet to be dispensed unless the heart rate is lower then the cut-off rate set by the physician, such as 115 bpm. Terbutaline can increase heart rates to dangerously high levels and therefore heart rate must be monitored. The patient notes after dosing herself with the first sublingual tablet that during the next 30 minutes, instead of having 5 contractions, she had only 3. Her physician instructed her to continue dosing every 30 minutes until she has one or no contractions every 30 minutes or until her heart rate is too high to allow drug delivery. Therefore the patient places her finger on the pulse reader and her pulse rate is 96, therefore the device dispenses another sublingual tablet. Heart rate and dosing history are electronically transmitted to the hospital nursing record. Also the patient is able to record the number of contractions using the device and this information is also transmitted to the electronic record. Over the next thirty minutes she has only one contraction. She waits for two hours until her contractions increase then she checks her pulse again and the device dispenses another tablet. Once the physician observed that the patient was able to monitor her heart rate and appropriately control her contractions she discharged her to home bed-rest with the device to use at home. The patient feels comfortable knowing that the same medication and route of administration that worked in the hospital can be administered easily at home. Usually terbutaline is dosed subcutaneously in the hospital and suffers from rapid uptake and tachycardia or it is dosed at home via oral tablets which have variable and delayed uptake pharmacokinetics. Also, currently there is no safety feature or device that allows tachycardia as a limiting physiological response to inhibit further dosing of the medication.

### Example 3

### Exemplary Inpatient System For Delivery And Monitoring Of Administration Of Alprazolam.

A 55 year-old male patient has just been diagnosed with colon cancer and is hospitalized for partial bowel obstruction and is awaiting exploratory surgery. He is having numerous episodes of anxiety attacks, which produce rapid pulse rate, high blood pressure and irritability towards the nurses. His surgeon orders for him a hand-held device, which dispenses very small sublingual tablets of 0.125 mcg of alprazolam in a controlled manner, including a 30 minute lock-out time. The device is RFID tagged to this patient. The patient feels less anxious knowing that he has control over his anxiety medication and that it can be dosed as needed instead of around-the-clock. He also likes the more immediate-release aspect of the sublingual delivery instead of swallowing a pill. The dosing of the alprazolam tablets is electronically transmitted to the nursing chart along with the patient's anxiety score, which he can enter on the device. If the patient is too sedated from the use of alprazolam and falls asleep, the patient-controlled aspect of the device will prevent him from being over-dosed with the medication. The nurse benefits from the device since she doesn't have to ask the patient about his level of anxiety and dose him with a pill multiple times per day.

Although the foregoing invention has been described in some detail by way of illustration and example for purposes of clarity and understanding, it will be apparent to those skilled in the art that certain changes and modifications may be practiced. Various aspects of the invention have been achieved by a series of experiments, some of which are described by way of the following non-limiting examples. Therefore, the description and examples should not be construed as limiting the scope of the invention, which is delineated by the appended description of exemplary embodiments.

1-48. (canceled)

49. A system for oral transmucosal delivery of a drug to a patient in an inpatient setting, comprising:
at least one drug delivery device for oral transmucosal drug delivery comprising a mechanism for patient identification, a lock-out means and a communication interface for bidirectional communication with an information network, wherein the patient self administers the medication on an as needed (PRN) basis.

50. The system according to claim 49, wherein said communication interface is a docking station and patient usage information is transmitted to the information network via the docking station and stored in at least one database.

51. The system according to claim 49, wherein said docking station is connected to the information network by way of a connection selected from the group consisting of a computer, a removable card, a phone line, a wireless connection and a USB port.

52. The system according to claim 49, wherein information is transmitted to, from or within said system by a communication means selected from the group consisting of a telephone, an Internet connection, a WAN network connection, a LAN network connection, a wireless connection and a satellite connection.

53. The system according to claim 49, wherein said at least one drug delivery device is connected to said information network by way of a docking station and patient usage information is transmitted to said information network and stored in at least one database.

54. The system according to claim 49, further comprising at least one input device for manually entering information into said system for delivery and monitoring delivery of said PRN medication.

55. The system according to claim 49, wherein said patient identification is accomplished using a biometric indicator selected from the group consisting of a Radio Frequency Identification (RFID) tag, a password, a pass code, fingerprint information, optical information, voice recognition, facial recognition and DNA analysis of a bodily fluid sample.

56. The system according to claim 49, wherein said oral transmucosal administration is sublingual administration.

57. The system according to claim 49, wherein said medication is used for the treatment of a condition selected from the group consisting of pain, anxiety disorders and panic attacks, nausea, insomnia, symptoms of pre-term labor and migraine.

58. The system according to claim 57, wherein the condition is pain and the drug is an opioid agonist selected from sufentanil, alfentanil and remifentanil, or a combination thereof.

59. The system according to claim 57, wherein the condition is an anxiety disorder or panic attack and the drug is a benzodiazepine.

60. The system according to claim 57, wherein the condition is nausea and the drug is selected from the group consisting of serotonin3 (5-HT3) receptor antagonists, dopamine receptor antagonists and cannabinoid receptor agonists.

61. The system according to claim 57, wherein the condition is insomnia and the drug is a benzodiazepine or non-benzodiazepine drug.

62. The system according to claim 57, wherein the condition is symptoms of pre-term labor and the drug is selected from the group consisting of beta-adrenergic receptor agonists, calcium channel blockers, and prostaglandin synthetase inhibitors.

63. The system according to claim 57, wherein the condition is symptoms of pre-term labor and the drug is.

64. The system according to claim 57, wherein the condition is migraine and the drug is selected from the ergot class and the triptan class of medications.

65. A method for oral transmucosal drug delivery of a PRN medication to a patient, comprising:
(a) providing at least one drug delivery device to said patient, wherein said drug delivery device comprises a means for patient identification, a lock-out means and a communication interface for bidirectional communication with an information network;
(b) activating said drug delivery device; and
(c) self administration of said medication on an as needed (PRN) basis by said patient.

66. The method according to claim 65, wherein said communication interface is a docking station and patient usage information is transmitted to the information network via said docking station and stored in at least one database.

67. The method according to claim 65, wherein said docking station is connected to the information network by way of a connection selected from the group consisting of a computer, a removable card or other media, a phone line, a wireless connection and a USB port.

68. The method according to claim 65, wherein said means for patient identification is a biometric indicator selected from the group consisting of an Radio Frequency Identification (RFID) tag, a password, a pass code, fingerprint information, optical information, voice recognition, facial recognition and DNA analysis of a bodily fluid sample.

69. The method according to claim 65, wherein said information network is a hospital computer system.

70. The method according to claim 65, wherein said PRN medication is used for the treatment of a condition selected from the group consisting of pain, anxiety disorders and panic attacks, nausea, insomnia, symptoms of pre-term labor and migraine.

71. The method according to claim 65, wherein the condition is pain and the drug is an opioid agonist selected from sufentanil, alfentanil and remifentanil, or a combination thereof.

72. The method according to claim 65, wherein the condition is an anxiety disorder or panic attack and the drug is a benzodiazepine.

73. The method according to claim 65, wherein the condition is symptoms of pre-term labor and the drug is terbutaline.
